(19) United States
(12) Patent Application Publication
(10) Pub. No.: US 2007/0162540 A1
(43) Pub. Date: Jul. 12, 2007

(54) Inter-agent communication

(76) Inventors: Habin Lee, Ipswich (GB); Patrik Mihailescu, Ipswich (GB); John W. Shepherdson, Sudbury (GB)

Correspondence Address: NIXON & VANDERHYE, PC, 901 NORTH GLEBE ROAD, 11TH FLOOR, ARLINGTON, VA, 22203, US

(21) Appl. No.: 10/594,424

(22) PCT Filed: Mar. 18, 2005
(86) PCT No.: PCT/GB05/01052

§ 371 Date: Sep. 26, 2006

(30) Foreign Application Priority Data
Mar. 30, 2004 (GB) 0407145.2

(51) Int. Cl. G06F 15/16

(52) U.S. Cl. 709/202

(57) ABSTRACT

A method is provided for communicating between software agents in a multi-agent system. Communication between agents is defined by means of a conversation model comprising a sequence of defined tasks which, when executed by a software agent, implement one or more roles in an inter-agent conversation. A software agent is provided which, when executed on a computer, is arranged to implement the method, in particular to receive a conversation model, for example one not previously known to the agent, to identify the ontology items used in the conversation model with respect to a defined role to be implemented by the software agent, to determine whether the agent is capable of providing or processing each of the identified ontology items, and if capable, to execute the tasks defined in the conversation model to implement the role.

The present invention relates to multi-agent systems and, in particular, to a software agent architecture and method by which software agents operating in that system may be arranged to participate in ad-hoc communications between one agent and another.

It has been suggested that for software agents in a multi-agent system to intercommunicate in support of a given service, software agents are required to share the same language, ontology (use of terminology) and conversation policy (CP, or interaction protocol) if they are to interpret exchanged messages successfully. Background information relating to Conversation Policies may be found for example in: M. Greaves, H. Holmback, and J. Bradshaw, “What is a conversation policy?”, in Proc. The Workshop on Specifying and Implementing Conversation Policies, Seattle, Wash., May 1999, pp. 118-131. Typically, different services apply different transaction rules to interactions between a service consumer and a service provider. It is therefore essential that agents participating in a multi-agent transaction are provided with functionality to support ad-hoc conversations, for example to implement an open electronic marketplace. Motivated by this, many efforts have been made to invent conversation models that may be used to represent and implement various kinds of CP. Recent developments in this field are described for example in: James J. Odell, H. Van Dyke Parunak, and Bernhard Bauer, “Representing Agent Interaction Protocols in UML”, AOSE Workshop at ICSE 2000, Limerik, Ireland, 2000; and S. Paurobally, J. Cunningham, N. Jennings, “Developing agent interaction protocols using graphical and logical methodologies”, the First International Workshop on Programming Multiagent Systems languages, frameworks, techniques and tools (PROMAS 2003), Melbourne, Australia.

However, most conversation models are intended for use by agent developers during the analysis or design phases of a multi-agent system development methodology. As a result, once a multi-agent system has been implemented and execution has begun, enabling an agent to use a new CP dynamically is typically impossible with known arrangements. Hence some research has been proposed to enable dynamic installation and execution of CPs in a multi-agent system (MAS).

One of the main application areas in which agent technology plays a central role is an electronic marketplace (eMarketplace). eMarketplace is a virtual marketplace where product consumers and sellers interact over a network such as the internet. One of the critical success factors for an eMarketplace is openness to enable new customers or product sellers to join the eMarketplace easily. In a real marketplace, each product seller provides a service controlled using different transaction rules to differentiate their service to customers from that of other sellers. Here, a transaction rule means a sequence of information exchanges between clients and a server to achieve an information trade. For example, in order to buy a book, a customer should send a book title, author, and publisher information to a book seller. Then, the book seller sends back an indication of the availability of the book. If the book is available, the customer should send payment information to the book seller. Finally, the book seller checks the credit status of the payment information and sends back a confirmation of the payment. This sequence of information exchanges should always be followed for a successful trade.

In an agent-based eMarketplace, agents perform the required transactions on behalf of human clients and sellers through the exchange of asynchronous messages that contain the necessary information. A CP defines and implements a transaction rule for an information trade. However, one of the disadvantages of an agent-based system in the eMarketplace is its inflexibility to respond to changes in the market configuration. For example, if a new book seller is introduced into the eMarketplace that uses a different transaction rule, the existing agents are not able to adapt to this new transaction rule as they do not have the same flexibility as human users. As a result, the capability of an agent to perform an “ad-hoc” conversation (one that requires an ad-hoc transaction rule) with another agent to achieve an information trade is considered one of the most important objectives towards achieving an open and flexible eMarketplace.

Iwao et al. have proposed a framework, called the Virtual Private Community (VPC), for the dynamic installation and execution of CPs by agents (see T. Iwao, Y Wada, M. Okada, and M. Amamiya: “A Framework for the Exchange and Installation of Protocols in a Multi-agent System”, CIA 2001, LNAI 2182 (2001) 211-222). They use a policy package which describes state transitions within a CP and provides application-specific actions that can be executed by an agent in each stage of the CP. The policy package can be dynamically transferred and installed into an agent to enable the execution of an ad-hoc CP. However, knowledge on the creation of outgoing messages and interpretation of incoming messages in each stage of the CP is supposed to be hard-coded in executable software components that are provided by third-party participants. This means a participating agent cannot become involved in the conversation process, which in turn prevents the agent updating its internal knowledge based upon the conversation process. Moreover, the VPC approach does not address the management of policy packages, e.g. how to provide a policy package, how to find a policy package and how to connect the internal logic of an agent with downloaded policy packages.

Ahn et al. have proposed a Flexible Conversation Model (FCM) as an executable CP description model (see Hyungjun Ahn, Habin Lee, Sungjoo Park: “A Flexible Agent System for Change Adaptation in Supply Chains, Expert Systems with Applications”, December 2003). An FCM consists of two sub-models: one is a state-transition model that describes the state transition rule for a specific CP; and the other is a state-action mapping model that maps to the required actions when the CP reaches a specific state within the CP. In their approach, an agent is provided with a CP model which describes the detail of an ad-hoc CP through meta-interaction with a librarian agent. However, they assume that all the required actions for any ad-hoc CP are known to an agent prior to installation of an FCM and which therefore can only be applied to a very limited range of applications, in particular to a supply-chain as illustrated in their paper. Furthermore, their CP model is tightly coupled with application-specific activities which prevents reuse of a particular CP logic in different applications.

The approaches of Iwao et al. and of Ahn et al., summarised above, are based on a finite-state-machine to represent a conversation policy, which has limitation when applied to a conversation that involves three or more roles.

Lee et al. have proposed a component-based approach to enable CP-independent interaction amongst multiple agents (see H. Lee, P. Mihailescu, and J. Shepherdson: “Conversational Component-based Open Multi-agent Architecture for Flexible Information Trade”, Lecture Notes in Artificial Intelligence (LNAI), 2782, 2003; and co-pending UK patent application number 0306294.0). In their approach, a so-called “conversational component” (C-COM) is used to encapsulate all the necessary process details and required agent actions for a service trade between multiple agents. A C-COM hides all the details of a CP used for a service trade whilst it provides an application programmers' interface (API) to communicate with an agent for obtaining required input parameters, and for returning produced ontology items to the agent. A service provider can publish its C-COM via a public library and a client agent may download the C-COM and execute it to interact with the server agent without knowing the details of the CP that is used. Their approach is relatively simple to implement, and a mediator agent has been proposed to mediate and manage a public library of registered C-COMs. The C-COM approach does not use a fixed conversation model to represent a conversation policy for an ad-hoc conversation, which enables the approach to be applied to any kind of conversation that requires two or more roles. Furthermore, the C-COM approach does not require a complex agent internal structure, which allows the approach to be adopted for multi-agent systems based on lightweight devices that have limited computing resources. However, the C-COM approach shares the common limitation with VPC and FCM that an installed C-COM cannot interact with and hence make use of its host agent's internal knowledge base.

According to a first aspect of the present invention, there is provided a method of communicating between software agents in a multi-agent system, comprising the steps of:
(i) receiving, at a software agent of said system, a conversation model defining a sequence of executable tasks for implementing a role in a conversation between agents;
(ii) identifying ontology items used in the conversation model in respect of said role;
(iii) determining, for each identified ontology item, whether the software agent is operable to provide or to process the identified ontology item; and
(iv) in the event that the result of said determining step (iii) is positive, executing the conversation model to implement said role in the conversation.

According to preferred embodiments of the present invention, a novel type of executable conversation model (CM) has been devised to define the stages in a conversation, for example an ad-hoc conversation, between software agents participating in the provision of a service. The CM is defined, preferably in the form of an XML specification, as a linked sequence of referenced tasks, each task, when executed in sequence by a software agent, being designed to implement a particular portion of the conversation. For example, a task may involve generating a particular message to be sent to another software agent participating (in a complementary role) in the conversation. The CM defines task sequences for each role in the conversation, There may be any number of different roles defined by the CM and each role may in practice be performed by a different software agent. A preferred software agent is arranged to dynamically receive, install and interpret a CM in order to communicate, in one or more roles, with other software agents, perhaps using conversation policies previously unknown to the software agent but details of which are described in the CM.

Preferably, the conversation model includes one or more message models defining, in respect of a particular service, messages referenced in the conversation model.

According to a second aspect of the present invention there is provided a software agent for use in a multi-agent system, which when executed on a computer provides:
means for receiving a conversation model defining a sequence of executable tasks for implementing a role in a conversation between software agents in said multi-agent system;
means for identifying ontology items used in a received conversation model in respect of said role;
determining means arranged, in respect of each identified ontology item, to determine whether the software agent is operable to provide or to process the identified ontology item; and
means for executing the conversation model to implement said role in the conversation in the event that the result of said determination is positive.

A software agent according to this second aspect of the present invention is provided with a preferred software agent architecture designed to interpret and to execute a CM, making use of the agent's current behaviour capabilities and existing knowledge base. In particular, the preferred agent architecture provides means for the agent to evaluate a CM to determine whether the agent can execute the CM, given its current range of available behaviours. In this context, a “behaviour” is a software module designed to perform a particular action within the software agent, for example to process one or more incoming messages to retrieve message contents. The behaviours available for execution within a preferred software agent are defined in a behaviour library. The determination as the whether or not the software agent is capable of executing a CM is made by checking whether the agent has, or can produce or process, all the required ontology items used within the CM, at least for a particular role to be performed by the agent in the conversation. Prior art arrangements do not take account of agents' differing abilities to execute CMs, assuming that all agents have the same ability to produce or process ontology items required to complete a conversation; this is not true for example in a typical multi-agent based open marketplace where different kinds of agent continuously join the marketplace.

The interpretation of a CM may be carried out by a model interpretation means within a software agent. In preferred embodiments of the present invention a software agent is provided with at least one CM, at least one behaviour model and means for interpreting and executing behaviour models and hence CMs in order to interact with participating agents implementing complementary roles. A software agent may have at least one behaviour model from the beginning of its operational life while a CM may be installed into the software agent on demand at any time.

In a preferred embodiment of the present invention, a software agent may be executed by a computer having sufficient processing and storage resources to execute an internal inference mechanism that allows the agent to interpret a knowledge model and to apply that knowledge to participate in ad-hoc conversations with other agents as they arise in providing a service to represented users. By “understanding” a provided knowledge model, a preferred software agent can determine the most appropriate behaviour to execute at any one time based upon its current knowledge of the outside world, rather than being reliant upon executing third-party provided software components.

According to preferred embodiments of the present invention, a novel task-oriented approach has been adopted for the modelling of a conversation process in contrast to the state transition-oriented approach of traditional CP modelling. This preferred task-oriented approach has particular advantages when applied to enable dynamic interpretation of conversation policies; something that is difficult to achieve with state transition-oriented conversation modelling. In the preferred task-oriented modelling approach, details of the tasks to be executed by a software agent can be specified and, in particular, the tasks to be executed by the agent to implement each of two or more roles in a given conversation. In a preferred embodiment of the present invention, a CM may comprise two or more conversation role models and a message model. A conversation role model describes all the tasks that should be performed by a software agent implementing a role in a conversation. As a result, the number of role models in a CM depends on the number of roles that are required in the conversation. Each task in a role model receives (produces) one or more input (output) messages from (for) other roles. The number of role models required to implement a conversation is dependent on the number of participating agent roles in the conversation. Each participating agent receives a corresponding role model from a mediator agent (which maintains registered role models for ad-hoc conversations) according to its role in an ad-hoc conversation. A message model describes all the messages used in the role models of a CM. Preferably, a message model may define the language, ontology, rules used to find recipients of a message, rules used to create or process ontology items that are used in the content of the message, and necessary attributes of the message.

In order to implement a given conversation policy, a software agent according to preferred embodiments of the present invention comprises means to interpret a corresponding conversation model (CM) and to perform appropriate tasks as defined in the CM to produce/process output/input messages defined for the conversation. Preferably, the software agent may comprise an expert system shell (for example, Java Expert System Shell, http://herzberg.ca.sandia.gov/jess/) wherein a set of rules guide the execution of a process to interpret incoming messages, to produce appropriate ontology items by executing one or more agent internal “behaviours”, to compose outgoing messages and to find appropriate receiver agents. In a preferred agent architecture the core components are a conversation scheduler and a task manager. The conversation scheduler schedules tasks that are defined in a CM to be executed at each stage of a conversation, while the task manager chooses appropriate agent behaviours to accomplish each of the scheduled tasks. Another component, called the Model Manager, is dedicated to managing all the installed CMs within the agent.

Preferably, each behaviour executable by an agent is defined by means of a behaviour description model which can be easily interpreted by the model manager to determine which behaviours can be used to execute a task in a CM. Each agent behaviour is defined by one or more input ontology items, an output ontology item, and the location and identity of an executable file that implements the behaviour.

According to a third aspect of the present invention there is provided a multi-agent system comprising a plurality of computers linked by means of a communications network, at least one of said computers being a intermediary server computer for storing conversation models in respect of one or more service providers, and wherein at least one of said computers is operable to execute a software agent as defined according to the second aspect of the present invention, to implement a conversation as defined in a conversation model supplied by said intermediary server computer.

Preferred embodiments of the present invention will now be described in more detail, by way of example only, with reference to the accompanying drawings of which:

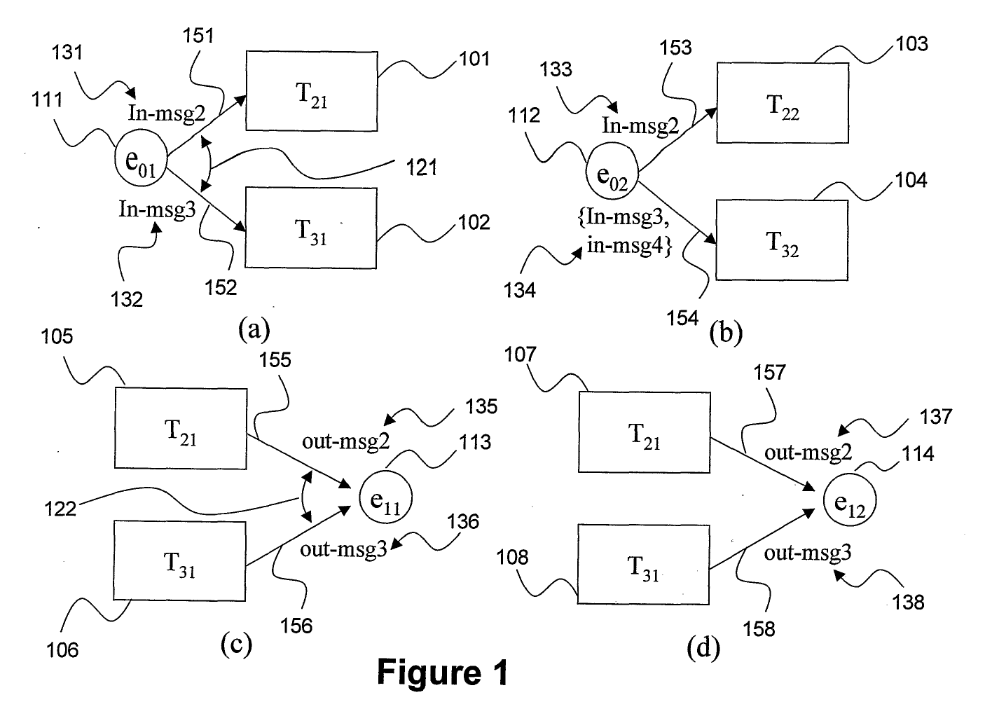

FIG. 1 shows, in graphical form, elements in a task-oriented conversation modelling technique used in preferred embodiments of the present invention;

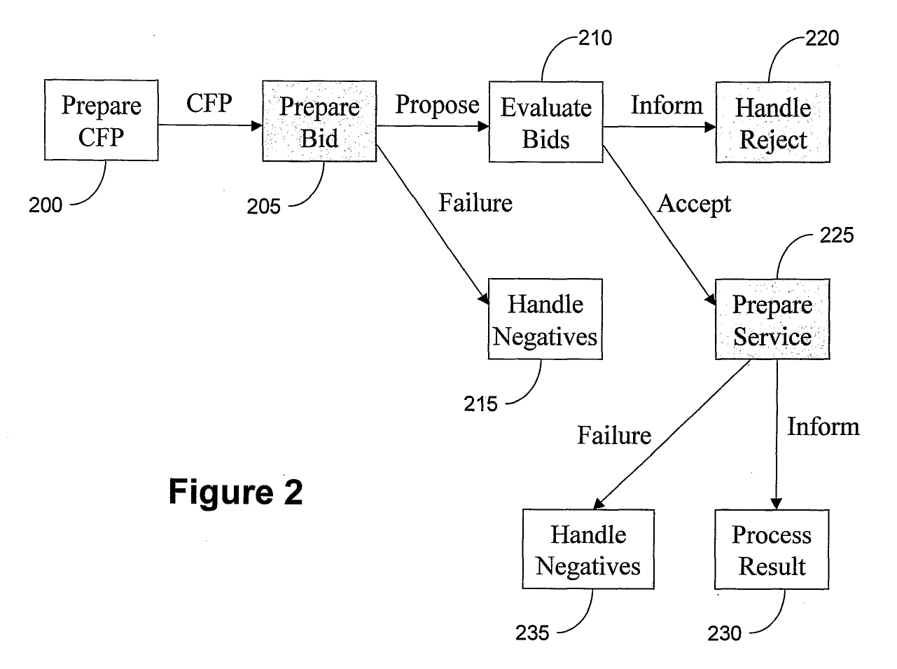

FIG. 2 shows, in overview, a graphical representation of a task-oriented conversation model implementing the known ContractNet protocol;

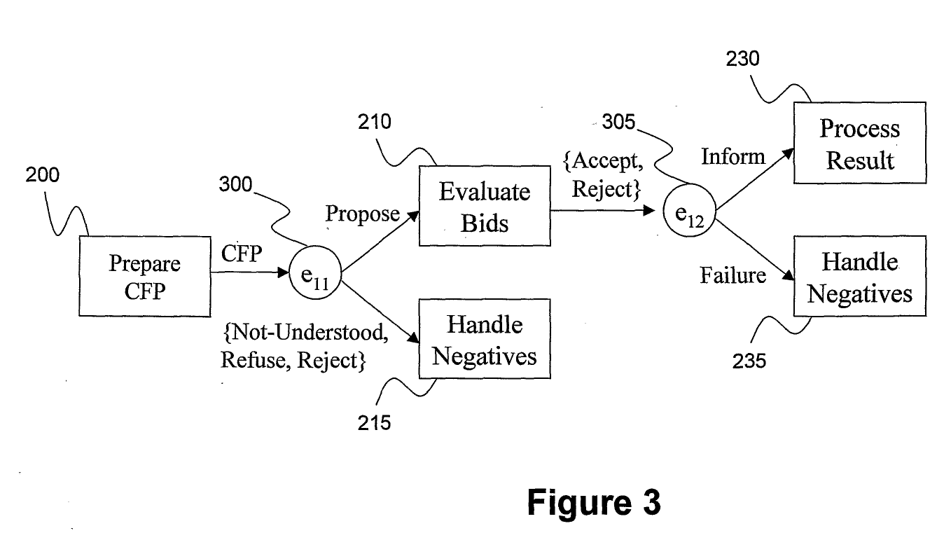

FIG. 3 shows a graphical representation of a conversation role model implementing an Initiator role in the ContractNet protocol of FIG. 2;

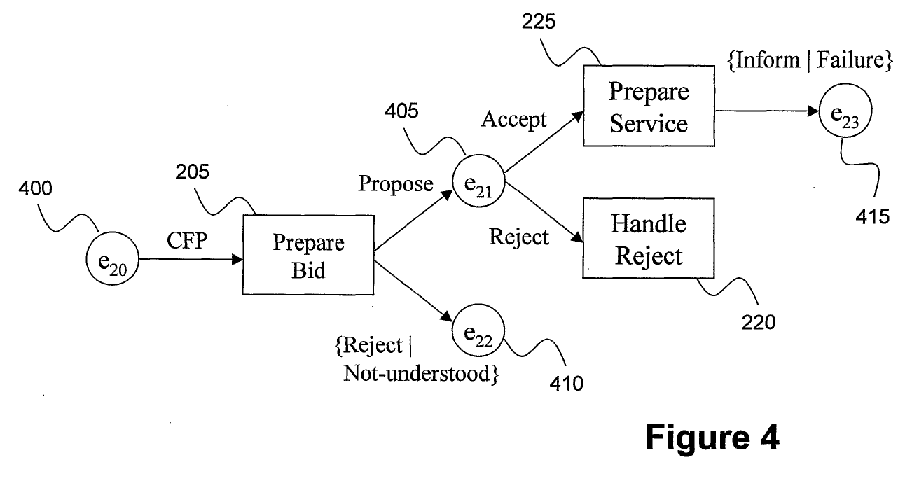

FIG. 4 shows a graphical representation of a conversation role model implementing a Responder role in the ContractNet protocol of FIG. 2;

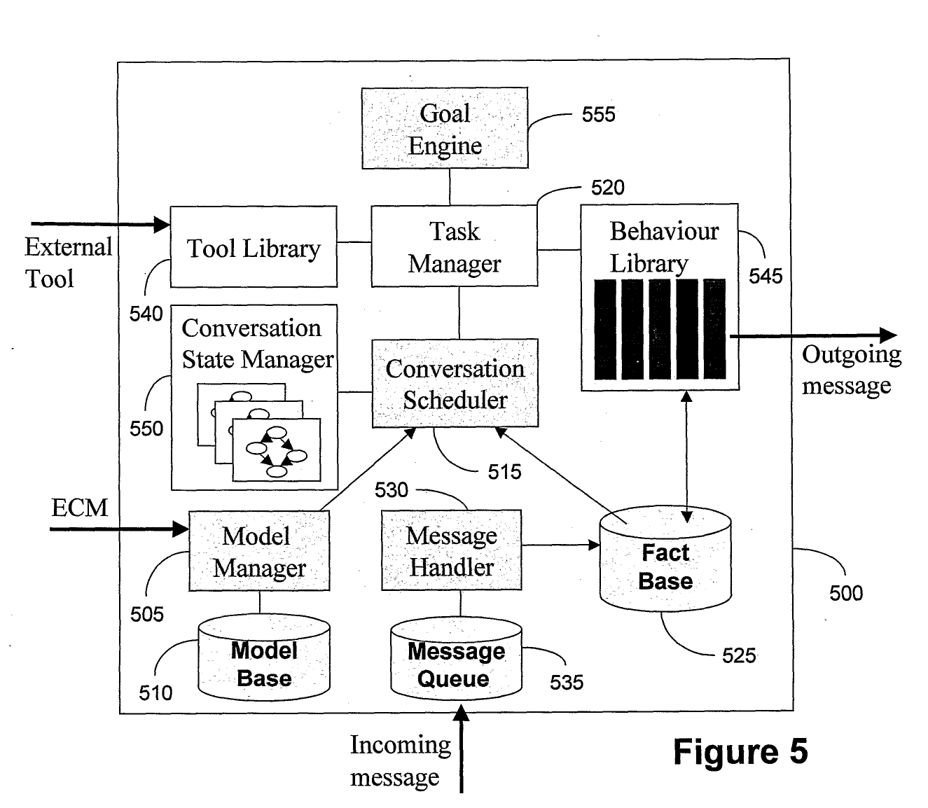

FIG. 5 shows a preferred software agent architecture for executing conversation models according to preferred embodiments of the present invention;

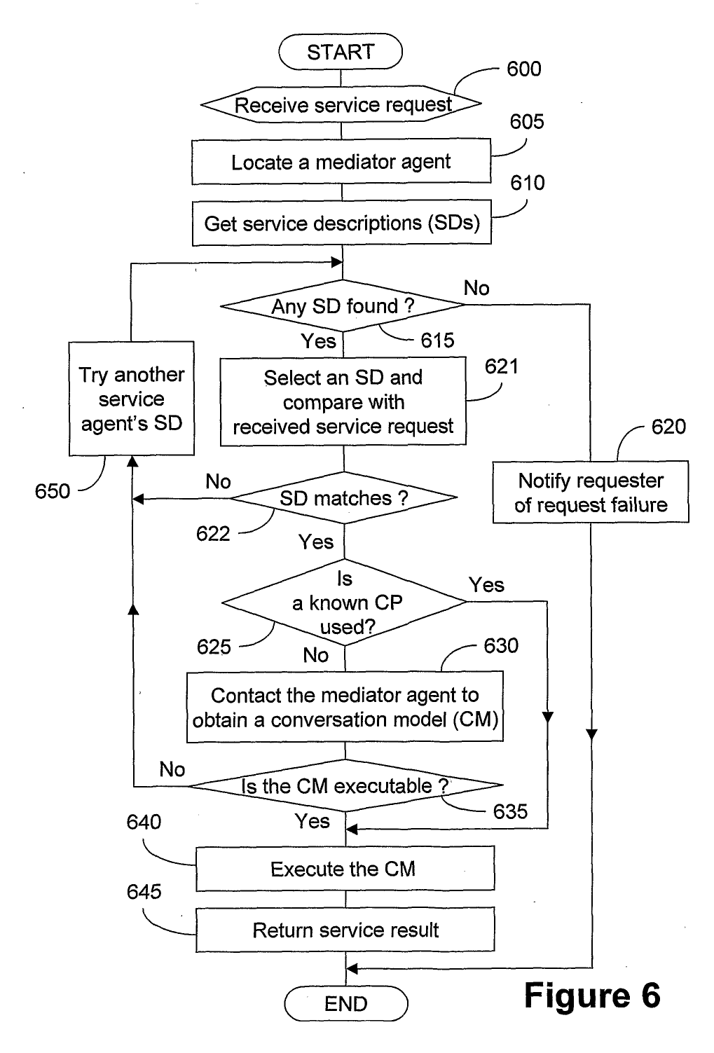

FIG. 6 is a flow chart representing the steps in a preferred process by which a component within the preferred agent architecture of FIG. 5 may initiate execution of an ad-hoc inter-agent conversation;

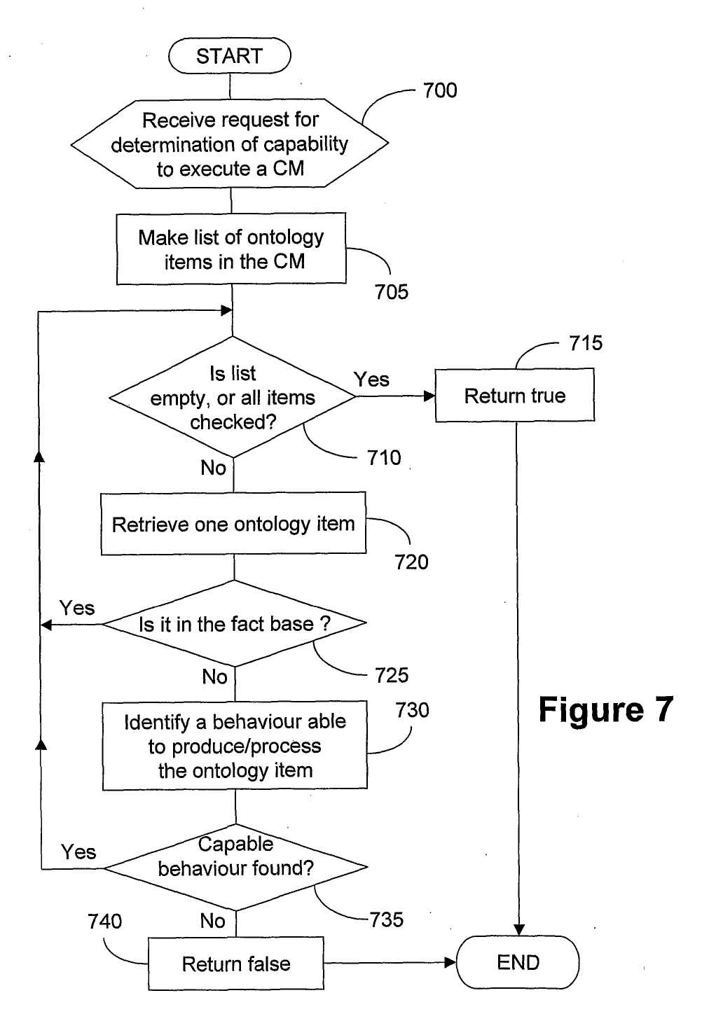

FIG. 7 is a flow chart representing the steps in a preferred process for implementing STEP 635 of FIG. 6; and

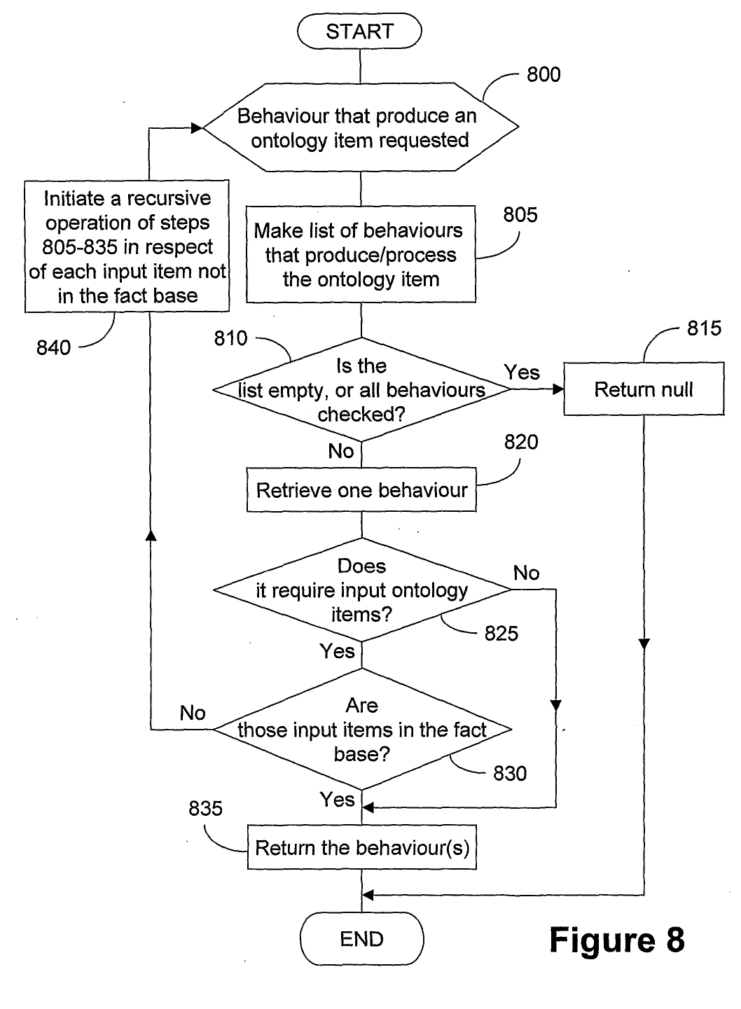

FIG. 8 is a flow chart representing the steps in a preferred process for implementing STEP 730 of FIG. 7.

### CONVERSATION MODELLING TECHNIQUE

A preferred task-oriented conversation modelling technique for use by embodiments of the present invention will firstly be described with reference to FIG. 1.

Referring to FIG. 1 a graphical representation is provided of some model elements in a preferred conversation modelling technique. In particular, model elements of the type shown in FIG. 1 are applied to define distinct “roles” within a conversation model (CM) wherein each role defines all the tasks that should be performed by a software agent implementing a role according to the CM. As a result, the number of role models defined in a CM depends upon the number of roles that are required to implement the corresponding conversation policy (CP). In FIG. 1, a conversation role model is shown to comprise a plural number of tasks 101-108 (represented as rectangles), connectors 111-114 (represented as circles), and message links 151-158 between a connector and a task (represented as directed arcs) for conveying messages 131-138. A connector 111-114 represents an arrival of an incoming message 131-134, an output of an outgoing message 135-138 or the expiration of a predefined timeout period. A task 101-108 represents a unit of work that an agent should execute by means of one or more “behaviours” to produce the required outgoing messages 135-138. A link 151-158 transfers one or more messages from a connector to a task and vice versa. The control of message flow in a role model is represented by the links 151-158 and their relationships 121-122. For instance, FIGS. 1 (a) and (b) show two possible message flows from a connector e₀₁ 111 and e₀₂ 112 respectively to following tasks. The relationship 121 between two message links 151, 152 in FIG. 1 (a) represents that an agent should wait until two messages (in-msg2 131 and in-msg3 132) arrive, and when that happens, it should execute two tasks T₂₁ 101 and T₃₁ 102 at the same time by forwarding each message to each task. On the other hand, FIG. 1 (b) represents that an agent should execute only one of two tasks T₂₂ 103 and T₃₂ 104 depending upon the input message 133/134. FIGS. 1 (c) and (d) show message flows from two tasks to a connector e₁₁ 113 and e₁₂ 114 respectively, provided that the two tasks have been activated at the same time. The relationship 122 between message links 155, 156 in FIG. 1 (c) indicates that both messages from two tasks T₂₁ 105 and T₃₁ 106 should reach the connector e₁₁ 113 and be forwarded to their receivers. On the other hand, FIG. 1 (d) indicates that only one output message 137 or 138 from two tasks T₂₁ 107 and T₃₁ 108 should reach the connector e₁₂ 114 and be forwarded to its receiver.

The principles of the preferred task-oriented conversation modelling technique described above with reference to FIG. 1 will now be applied in a preferred embodiment of the present invention to the well-known ContractNet protocol and will be described with reference to FIG. 2. Background information on the ContractNet protocol may be obtained from publications by the Foundation for Intelligent Physical Agents (FIPA), made available over the internet for example at http://www.fipa.org.

Referring to FIG. 2, a preferred task-oriented representation is shown for the ContractNet protocol. There are two roles represented by the linked tasks shown in FIG. 2: the role of an Initiator agent with responsibility for carrying out tasks 200, 210, 215, 230 and 235; and the role of one or more Responder agents, each with responsibility for carrying out tasks 205, 220 and 225. In order to implement the ContractNet protocol in respect of a particular transaction, software agents are arranged to implement the Initiator and Responder role models for the protocol as defined in a preferred task-oriented CM (to be described in more detail below with reference to FIG. 3 and FIG. 4).

According to the ContractNet protocol represented in FIG. 2, the process begins when an Initiator agent executes a task 200 to generate and output a “call for proposal” (CFP) message which describes a required service that the Initiator agent wants to receive from a service provider agent (operating in a Responder role). On receipt of a “CFP” message a service provider agent executes a Prepare Bid task 205 to create a Bid proposal which describes how the service provider can provide the required service, and the bid proposal is communicated, in response, to the Initiator agent. The Initiator agent executes an Evaluate Bids task 210 to receive any bid proposals and to evaluate these bids according to pre-defined criteria to determine a winning Bid On selecting a winning bid at task 210, the Initiator agent then notifies the winning service provider (Responder) which, in turn, is triggered to execute a Prepare Service task 225 to provide the required service to the Initiator agent, handled by the Initiator agent at task 230. Failures at each stage are recognised by the Initiator agent through appropriate Handle Negatives tasks 215 and 235, while the unsuccessful bidding Responder agents receive rejection messages by means of Handle Reject tasks 220.

Preferred task-oriented conversation role models for each of the Initiator and Responder points of view will now be described in more detail for the ContractNet protocol with reference to graphical representations of the respective conversation role models shown in FIG. 3 and FIG. 4 respectively.

Referring firstly to FIG. 3, the ContractNet process is shown to begin when an Initiator agent executes a Prepare CFP task 200. The output message from the Prepare CFP task 200 is a message having performative “CFP”. After the message has been sent, control proceeds to connector e₁₁ 300 at which point the Initiator agent waits a predetermined time to receive messages from receivers of the CFP message. All received messages having performative “Propose” are forwarded from the connector e₁₁ 300 to the Evaluate Bids task 210, while messages having performative “Not Understood”, “Refuse” or “Reject” are forwarded to the Handle Negatives task 215. On evaluating the contents of received “Propose” messages, the Evaluate Bids task 210 task outputs messages having either an “Accept” or “Reject” performative. After sending the output messages, control proceeds to connector e₁₂ 305 at which point the Initiator agent waits until one of an “Inform” or a “Failure” message is received. An “Inform” message is forwarded from the connector e₁₂ 305 to a “Process Result” task 230 to receive the required service, while a “Failure” message is forwarded from the connector e₁₂ 305 to a Handle Negatives task 235 to terminate the conversation.

Referring to FIG. 4, a graphical representation of the preferred conversation role model of the ContractNet protocol from the Responder agent's point of view is shown. The preferred conversation role model of the Responder role starts with a connector e₂₀ 400 that represents the arrival of a message from an agent implementing the Initiator role. The input message of the process is a message having “CFP” as performative. The “CFP” message is forwarded to the task PrepareBid 205. The Prepare Bid task 205 uses the content of the “CFP” message to produce a “Propose”, “Reject”, or “Not-understood” message. If the Prepare Bid task 205 produces a “Reject” or “Not-understood” message, control of the conversation moves forward to the connector e₂₂ 410 that represents the forwarding of the message and finishes the conversation with the Initiator agent. Otherwise, control of the conversation now reaches connector e₂₁ 405 and the Responder agent waits until it receives an “Accept” or “Reject” message. If the received message is an “Accept” message, the agent executes task Prepare Service 225 that will execute one or more behaviours of the agent to produce either an “Inform” or a “Failure” message and output it to connector e₂₃ 415. In particular, if capable, the Responder agent may execute a private business process to supply the required service to the Initiator agent under the Prepare Service task 225. Otherwise, the Responder agent finishes the conversation by executing a Handle Reject task 220 arranged to process the “Reject” message received from the Initiator agent.

The preferred conversation role models shown graphically in FIG. 3 and FIG. 4 are specified using the Extensible Markup Language (XML). A structured specification in this form in particular enables software agents to interpret them more easily. For the Initiator conversation role model shown graphically in FIG. 3, the specification takes the following form.

<RoleModel>
<Conversation>ContractNet</Conversation>
<Role>Initiator</Role>
<Task name=PrepareCFP>
<OutputMsg id=msg01 performative=CFP cardinality=N />
</Task>
<Task name=EvaluateBids>
<InputMsg id=msg03 performative=Propose cardinality=N />
<OutputMsg id=ms04 performative=Accept />
<OutputMsg id=msg05 performative=Reject />
</Task>
<Task name=HandleNegatives>
<InputMsg id=msg06 performative=Not-Understood cardinality=N />
<InputMsg id=msg07 performative=Refuse cardinality=N />
<InputMsg id=msg08 performative=Reject cardinality=N />
</Task>
<Task name=ProcessResult>
<InputMsg id=msg09 performative=Inform cardinality=1 />
</Task>
<Task name=HandleFailure>
<InputMsg id=msg10 pertormative=Failure cardinality=1 />
</Task>
<Connector name=e11 type=middle>
<PreTask>PrepareCFP</PreTask>
<PostTask name=EvaluateBids MsdId=msg02 />
<PostTask name=HandleNegatives Msg Id=msg03 />
<Receive>
<Type>Timed</Type>
</Receive>
</Connector>
<Connector name=e₁₂ type=middle>
<PreTask>EvaluateBids</PreTask>
<PostTask name=ProcessResult Msg Id=msg04 />
<PostTask name=HandleNegative MsgId=msg05 />
<Receive>
<Type>Timed<Type>
</Receive>
</Connector>
</RoleModel>

A conversation role model specification preferably comprises <Conversation>, <Role>, <Task>, and <Connector> tags. A <Conversation> tag identifies, by name, the Conversation Policy (CP) to be specified by the model, in this example a CP directed to implementing the ContractNet protocol. A <Task> tag contains the name, input messages, and an output message of the task. An <InputMsg> tag has an identifier (id), performative, and cardinality as its attributes. The cardinality attribute represents how many input messages having the specified performative are used in the task. A <Connector> tag has a name and type as its attributes. A connector type can be one of “initial”, “middle”, and “terminal”. An <Initial> connector exists only in a Responder role and initiates the execution of a conversation role model for the Responder. A connector of type “terminal” represents that the conversation has reached its termination point. A <Connector> tag has one or more <PreTask> tags each referencing a preceding task, and one or more <PostTask> tags each of which reference a task to follow.

In order to define each of the messages referenced in a conversation role model, e.g. to define message “msg03”, a message specification is provided, preferably using XML, to specify all the information required by an agent 500 for composing and interpreting messages and their contents used in respect of a particular application. A conversation role model states only that messages having a specific performative should be exchanged among participating roles in a conversation, whereas a message specification states what ontology items should be included in that particular type of message for that specific application. Thus, a conversation role model may remain application-independent, while a message model tailors the messages referenced in each role model to a specific application. The following shows an example message specification for a “QueryProductinfo” service that uses the ContractNet CP as specified above.

<Message id=msg03 performative=PROPOSE>
<Service name=QueryProductInfo type=Retail/>
<Content>
<AgentAction>
<Name>Sell</Name>
<Concept>MusicCD</Concept>
</AgentAction>
</Content>
<Constraint>
(Propose (Content (Sell (MusicCD (Price ?p)))))
(NotNull ?p)
</Constraint>
</MessageContent>

This message specification defines the message having id attribute “msg03” and performative “Propose”. The message is defined to have an agent action ontology item ‘Sell’ that in turn has a concept ontology item “MusicCD”. Furthermore, there is a constraint that all the instances of this message specification should have non-null values of the price attribute.

Other specifications for the message type “msg03”, and the other message types referenced in registered CMs, would typically be defined and stored for use by software agents in respect of each distinct application of the conversation policies (e.g. for the ContractNet protocol) that are registered by service provider agents.

Agent Architecture

A preferred architecture for a software agent will now be described with reference to FIG. 5 according to a preferred embodiment of the present invention. A software agent having the preferred architecture is arranged to interpret and to execute one or more roles defined within a received CM in order to implement a corresponding conversation policy.

Referring to FIG. 5, a software agent 500 comprises a model manager 505 arranged to receive a required CM from an external source or from an internal model base 510. Execution of a CM, in particular execution of a role model within the CM by the software agent 500 implementing the corresponding role, is controlled by a conversation scheduler 515. The conversation scheduler 515 is operable to interpret a conversation role model and, with access to a task manager 520, to arrange for individual tasks within the conversation role model to be executed. The conversation scheduler 515 is also arranged with access to a fact base 525. A message handler 530 is arranged to monitor the arrival of messages incoming to the agent 500 via a message queue 535 and to receive their contents insofar as they apply to a task being executed by the task manager 520.

In order to execute tasks notified to it by the conversation scheduler 515, the task manager 520 is arranged with access to a tool library 540 and to a behaviour library 545. Tools contained in the tool library 540, or accessible from an external source of tools, and behaviours contained in the behaviour library 545, are used in the execution of a task, for example in the generation of an output message containing a particular piece of information, or to process information contained in an input message received via the message handler 530. Behaviours (545) access information stored in the fact base 525 as required to complete certain aspects of a task being executed.

A conversation state manager 550 is arranged to monitor the overall status of a CM being executed. In particular, the conversation state manager 550 is arranged with access to the conversation scheduler 515 to monitor progress in the execution of a CM, and with access to the fact base 525 to monitor the status of incoming messages insofar as they relate to a CM being executed.

A CM containing a description of an ad-hoc conversation may be provided dynamically to the agent 500 by means of the model base 510. The agent 500 may download a CM itself from an agent operating as a mediator agent for the supply of ad-hoc CMs. The mediator agent may maintain all the CMs provided by service agents to enable other agents to interact with those service agents in respect of a particular service. A downloaded CM is registered in the model base 510 by the model manager 505.

The software agent 500 may further comprise a goal engine 555 arranged to achieve pre-defined goals by use of an inference shell. A goal may comprise one or more defined sub-goals; for example, a goal “Buy a music CD” may comprise sub-goals such as “Obtain CD information from user”, “Identify the best dealer”, “Obtain from the user a confirmation on a transaction with the best dealer”). Under the control of the goal engine 555, the software agent 500 may achieve each defined sub-goal by selecting and executing one or more suitable behaviours in behaviour library 545. For example, the sub-goal “Obtain CD information from user” and “Obtain from the user a confirmation on a transaction with the best dealer” may be achieved using specific behaviours directed to capturing user input. If a sub-goal cannot be achieved by executing internal behaviours from the behaviour library 545 (for example the sub-goal “Identify the best dealer” would not in practice be achievable using such behaviours alone), the software agent 500 may pass a service request (which is specified in an XML file) to the conversation scheduler 515 which will then interact with other software agents to achieve the sub-goal through obtaining and executing an appropriate CM.

The conversation scheduler 515 provides application programming interfaces (APIs) to enable other software components of the agent 500, e.g. goal engine 555, to interact with it. In particular, a software component of the agent 500 may initiate a new conversation using these APIs. A request for the initiation of a new conversation may be made by passing an XML file to the conversation scheduler 515 that describes the service required by the requesting component within the agent 500. The process operable by the conversation scheduler 515 to handle a service request from any other component within the agent 500 will now be described with reference to the process flow chart shown in FIG. 6.

Referring to FIG. 6, on receipt of a service request at STEP 600 from an agent software component, e.g. goal engine 555, the conversation scheduler 515 arranges, at STEP 605, for the model manager 505 to locate a mediator agent that stores service descriptions and corresponding CMs registered by each of the service-providing agents. At STEP 610 the conversation scheduler 515 requests from the located mediator agent a set of service descriptions (SDs) that have been registered with the mediator agent. If, at STEP 615, no SD is found, the conversation scheduler 515 firstly notifies the requester, at STEP 620, that the request has failed and the process ends. Otherwise, the conversation scheduler 515 proceeds to STEP 621 to select one of the supplied SDs and to compare it with the received service request.

An SD may be specified according to a standard format specified by FIPA (referenced above). An example of an SD is as follows:

<ServiceDescription>

<Name> QueryProductInfo </Name>
<Type> Retail </Type>
<Ontology> ec.contract </Ontology>
<Language> SL0 </Language>
<Protocol> ContractNet </Protocol>
<Property name=domain, value=music />

</ServiceDescription>

According to the FIPA specification, an SD comprises service name, type, ontology, language, and protocol (conversation policy) parameters to be used in messages to enable a corresponding transaction to identify the service and service-specific properties. An SD passed from the goal engine 555 to the conversation scheduler 515 need not necessarily include the protocol tag. The service request received at STEP 600 is compared at STEP 621 with SDs obtained from a mediator agent by comparing each field, other than the protocol tag. If, at STEP 622, the selected SD does not match the received service request, then at STEP 650, the conversation scheduler 515 tries to access another service agent's SD, if any, and processing returns to STEP 615.

If, at STEP 622, the conversation scheduler 515 finds that the comparison identifies a matching SD among the SDs obtained from the mediator agent, the conversation scheduler 515 at STEP 625 arranges for the model manager 505 to check whether the conversation policy referenced by the matching SD is known to the agent 500. If, at step 625, the matching SD references a known conversation policy, then at STEP 640 the conversation scheduler 515 simply arranges to execute the CM and at STEP 645 returns the service result arising from execution of that CM. Otherwise, if, at STEP 625 the CM is not known to the agent 500, then at STEP 630 the conversation scheduler 515 contacts the mediator agent again, via the model manager 505, to obtain a CM for the referenced conversation policy and at STEP 635 triggers the model manager 505 to determine whether or not the obtained CM is executable by the agent 500. If, at STEP 635, it is executable, then at STEP 640 the conversation scheduler 515 arranges to execute it, and at STEP 645 returns the service result arising from its execution. Otherwise, at STEP 650, the conversation scheduler 515 tries to access another service agent's SD and processing returns to STEP 615.

The check to be performed by the model manager 505, at STEP 635, as to whether the agent 500 can execute the CM is based upon a determination of whether the ontology items used in the CM can be provided or processed by the agent 500. A preferred process by which the model manager 505 may make this determination at STEP 635 will now be described with reference to the flow chart shown in FIG. 7.

Referring to FIG. 7, on receiving a request for a determination of the capability of the agent 500 to execute a given CM at STEP 700, the model manager 505 begins at STEP 705 by identifying all the ontology items that need to be provided or processed in the CM. Ontology items may include parameters within messages that need to be generated or processed by the agent 500 when executing a particular task within the CM and for which values need to be obtained or interpreted by the agent 500 in respect of a particular service, e.g. the price of a book, the title of a research paper. If, at STEP 710, there appear to be no ontology items to be provided or processed in the CM, then at STEP 715 the model manager 505 generates a signal to indicate that the agent 500 is capable of executing the CM, and the process of determination under STEP 635 ends.

If at STEP 710 ontology items are identified, then at STEP 720 the model manager 505 retrieves one ontology item at a time from the list created at STEP 705, and determines firstly whether, at STEP 725, a value for the retrieved item is stored in the fact base 525. If it is, then processing returns to STEP 710 to check whether all items in the created list of ontology items have been checked. If, at STEP 725, a value for the retrieved ontology item is not in the fact base 525, then at STEP 730 the model manager 505 checks each of the behaviours in the behaviour library 545 in order to find one that can provide a value for or process the retrieved ontology item. If, at STEP 735, a suitable behaviour is found, then processing returns to STEP 710 to check whether all items in the created list of ontology items have been checked. Otherwise, at STEP 740, the model manager 505 generates a signal to indicate that the agent 500 is not capable of executing the CM, and the process of determination ends. If at STEP 810 all ontology items in a created list have been checked with positive results, then at STEP 715 the model manager 505 generates a signal to indicate that the agent 500 is capable of executing the conversation model, and the process of determination under STEP 635 ends.

A process will now be described, with reference to the flow chart of FIG. 8, by which, at STEP 730 of FIG. 7, the model manager 505 is able to identify a behaviour among those stored in the behaviour library 545 that is capable of providing a value for or processing a given ontology item.

Referring to FIG. 8, the process begins at STEP 800 when the model manager 505 receives a request to identify at least one behaviour that is able to provide or process the given ontology item. At STEP 805, the model manager 505 analyses the behaviours stored in or referenced in the behaviour library 545 and creates a list of those behaviours that appear to be capable of producing or processing the given ontology item. If, at STEP 810, it is found that the list of capable behaviours created at STEP 805 is empty, then at STEP 815 the model manager 505 generates a signal to indicate that no suitable behaviours can be found, and the process under STEP 730 ends.

If, at STEP 810, the list of behaviours is not empty and one or more potentially capable behaviours have been found, then at STEP 820 the model manager 505 retrieves one behaviour referenced in the list and at STEP 825 determines whether the retrieved behaviour requires the input of any further ontology items as part of a process to handle the given ontology item. If it does not, then the retrieved behaviour is deemed capable of providing values for or processing the given ontology item and processing proceeds to STEP 835 to return the retrieved behaviour, or at least a reference to it, as the behaviour identified at STEP 730, and the process ends.

If, at STEP 825, the retrieved behaviour does require input of one more further ontology items, then at STEP 830 a check is made as to whether values for each of the one or more further ontology items are available from the fact base 525. If all further ontology items are available from the fact base 525, then at STEP 835 the retrieved behaviour is returned, or at least a reference to it is returned, as the behaviour identified at STEP 730, and the process ends. However, if at STEP 830 any of the required input ontology items are not available from the fact base 525, then the model manager 505 may be arranged to attempt to identify one or more further behaviours (sub-behaviours) from the behaviour library 545 that would be able to provide each required input ontology item found not to be available from the fact base 525. Preferably, the model manager 505 achieves this at STEP 840 by triggering a new sub-process employing the same process steps 805 to 835 of FIG. 8 for each required input ontology item and, if necessary, applying this sub-process recursively to a predetermined maximum recursive depth. For example, if a first pass through steps 805 to 835 does not yield a capable behaviour, then the model manager 505 is arranged to make a second pass through steps 805 to 835 in respect of each of one or more required input items found not to be available from the fact base 525. If this second pass finds capable sub-behaviours for all those input ontology items requiring them, then at STEP 835 a top-level behaviour and one or more sub-behaviours will be returned in respect of the given ontology item and hence identified under STEP 730, otherwise at STEP 815 the model manager 505 generates a signal to indicate that no suitable behaviours can be found, and the process under STEP 730 ends.

While the maximum recursive depth may optionally be set to a value greater than 1 to give the model manager 505 an opportunity to identify sub-behaviours to identified sub-behaviours if required, in practice operating to a greater recursive depth is likely to result in an impractically complex arrangement of nested behaviours that would need to be executed by the agent 500 in order to handle a given ontology item arising in the CM being executed, and this would only be advisable as a last resort once all top-level behaviours have been analysed and a simpler behavioural solution is known not to exist.

Behaviour Descriptions

In a preferred embodiment of the present invention, an agent 500 is arranged to store behaviour description models of a preferred type, to be described below, in the behaviour library 545. The preferred behaviour description models are XML files structured, in particular, to enable the model manager 505 to perform the capability determination STEP 730 of FIG. 7 through in the process steps of FIG. 8.

An example of a preferred behaviour description model in respect of a particular agent behaviour is as follows.

<BehaviourDescription>
<Name>BidsEvaluator</Name>
<ClassPath>com bt.agent.behaviours.BidsEvaluator</ClassPath>
<InputOntology>ec.contract.BidList</InputOntology>
<InputOntology>ec.contract.Strategy</InputOntology>
<OutputOntology>ec.oontract.Bid</OutputOntology>
</BehaviourDescription>

In this example, the description model relates to a behaviour having the unique name “BidsEvaluator”. The <ClassPath> tag references a location from where the agent 500 can load an executable file to implement the behaviour. The <InputOntology> tag represents an input ontology item that is needed to execute the behaviour. The behaviour described in the example above requires two input ontology items: “BidList” and “Strategy”. To each ontology item is attached a reference to a location where a class file of the ontology item can be found for an instantiation of an ontology item. Finally, the output ontology item of the behaviour is a “Bid” ontology item which is selected by the behaviour “BidEvaluator” based upon the two input ontology items.

Input and output ontology items are clearly identifiable in this behaviour description structure by reading the parameters enclosed by <InputOntology> and by <OutputOntology> tags. It is therefore a simple matter for the model manager 505 executing the process of FIG. 8 to carry out STEP 730 of FIG. 7, described above, to identify a potentially suitable behaviour and to determine its capability to provide/process a given ontology item on the basis of an analysis of the behaviour descriptions stored in the behaviour library 545.

Having identified one or more behaviours capable of executing each of the tasks specified in a conversation role model, the agent 500 may then proceed to participate in the conversation, for example an ad-hoc conversation, under the overall control of the conversation scheduler 515 and under the task-specific control of the task manager 520.

1. A method of communicating between software agents in a multi-agent system, comprising the steps of:
(i) receiving, at a software agent of said system, a conversation model defining a sequence of executable tasks for implementing a role in a conversation between agents;
(ii) identifying ontology items used in the conversation model in respect of said role;
(iii) determining, for each identified ontology item, whether the software agent is operable to provide or to process the identified ontology item; and
(iv) in the event that the result of said determining step (iii) is positive, executing the conversation model to implement said role in the conversation.

2. A method as in claim 1, wherein the conversation model includes one or more message models defining, in respect of a particular service, messages referenced in the conversation model.

3. A method as in claim 1, wherein said determining step (iii) comprises:
a) identifying at least one behaviour model which, when executed by the agent, is operable to provide or to process the identified ontology item; and
b) identifying, in respect of a particular service, a message model defining each message referenced in the conversation model.

4. A method as in claim 3, wherein at step a), identifying said at least one behaviour comprises determining whether said at least one behaviour is operable to generate the ontology item as an output ontology item, and wherein if said at least one behaviour requires an input ontology item, determining whether the input ontology item is available in a fact base of the agent or may be produced as an output ontology item by another behaviour available to the agent.

5. A method as in claim 1, wherein the conversation model defines an agent conversation previously unknown to the agent.

6. A method as in claim 1, wherein the conversation model defines a plurality of roles in an inter-agent conversation, each role comprising a linked sequence of tasks which when executed by a software agent implement corresponding stages in a conversation, and wherein a task is linked to another task in the role by means of a connector representative of either the receipt of a message from, or the output of a message to another agent implementing a complementary role defined in the conversation model.

7. A method as in claim 1, wherein the software agent implements an initiator role defined in the conversation model and another software agent implements a responder role defined in the conversation model.

8. A method as in claim 1, wherein a task, when executed by the agent, causes the agent to receive one or more input messages and to generate one or more output messages.

9. A method as in claim 1, wherein at step (iv) executing the conversation model comprises selecting, for each task to be executed in respect of said role, one or more behaviours which, when executed by the agent, implement the task.

10. A software agent for use in a multi-agent system, which when executed on a computer provides:
means for receiving a conversation model defining a sequence of executable tasks for implementing a role in a conversation between software agents in said multi-agent system;
means for identifying ontology items used in a received conversation model in respect of said role;
determining means arranged, in respect of each identified ontology item, to determine whether the software agent is operable to provide or to process the identified ontology item; and
means for executing the conversation model to implement said role in the conversation in the event that the result of said determination is positive.

11. A software agent as in claim 10, wherein said means for executing the conversation model comprise:
scheduling means for selecting a task to be executed in the conversation model; and
a task manager arranged with access to a library of behaviours to select one or more behaviours to be executed to implement the selected task.

12. A software agent as in claim 11, wherein the software agent further comprises a fact base for storing ontology items, and wherein behaviours in said library of behaviours are arranged with access to said fact base to obtain input ontology items.

13. A software agent as in claim 10, wherein the conversation model includes one or more message models defining, in respect of a particular service, messages referenced in the conversation model.

14. A software agent as in claim 10, wherein said determining means are operable:
to identify at least one behaviour model which, when executed by the agent, is operable to provide or to process the identified ontology item; and
to identify, in respect of a particular service, a message model defining each message referenced in the conversation model.

15. A software agent as in claim 14, wherein identifying said at least one behaviour comprises determining whether said at least one behaviour is operable to generate the ontology item as an output ontology item, and wherein if said at least one behaviour requires an input ontology item, determining whether the input ontology item is available in a fact base of the agent or may be produced as an output ontology item by another behaviour available to the agent.

16. A software agent as in claim 10, wherein the conversation model defines an agent conversation previously unknown to the agent.

17. A software agent as in claim 10, wherein the conversation model defines a plurality of roles in an inter-agent conversation, each role comprising a linked sequence of tasks which when executed by the software agent implement corresponding stages in a conversation, and wherein a task is linked to another task in the role by means of a connector representative of either the receipt of a message from, or the output of a message to another agent implementing a complementary role defined in the conversation model.

18. A software agent as in claim 10, wherein the software agent, when executed, is arranged to implement an initiator role defined in the conversation model.

19. A software agent as in claim 10, wherein a task, when executed by the software agent, causes the software agent to receive one or more input messages and to generate one or more output messages.

20. A software agent as in claim 10, wherein said means for executing the conversation model are operable to select, for each task to be executed in respect of said role, one or more behaviours which, when executed by the software agent, implement the task.

21. A software agent as in claim 11, wherein said scheduling means are responsive to receipt, at a message queue, of a message defined in the conversation model in respect of a task to be executed, to schedule execution of said task to be executed.

22. A method as in claim 2, wherein said one or more message models comprise an indication of a language, ontology, rules for locating one or more recipients of a respective message, rules for creating one or more ontology items used within the contents of the message, and attributes of the message.

23. A method as in claim 3, where in said at least one behaviour model defines one or more input ontology items, one or more output ontology items, and the location of an executable file that implements the respective behaviour.

24. A method as in claim 1, wherein the conversation model, in defining a role to be executed, identifies the name of the role and, for each task defined in the role, one or more input messages to be received and one or more output messages.

25. A multi-agent system comprising a plurality of computers linked by means of a communications network, at least one of said computers being a intermediary server computer for storing conversation models in respect of one or more service providers, and wherein at least one of said computers is operable to execute a software agent as defined according to claim 10 to implement a conversation as defined in a conversation model supplied by said intermediary server computer.
